(19) United States
(12) Patent Application Publication
(10) Pub. No.: US 2005/0086119 A1
(43) Pub. Date: Apr. 21, 2005

(54) Content delivery apparatus and content creation method

(76) Inventors: Tsuyoshi Komuro, Osaka (JP); Fumio Tanaka, Osaka (JP); Masaru Eshima, Osaka (JP); Kiyoshi Ishikawa, Osaka (JP); Yoshihiro Hirata, Osaka (JP); Hidekazu Imatani, Osaka (JP)

Correspondence Address: MILES & STOCKBRIDGE PC, 1751 PINNACLE DRIVE, SUITE 500, MCLEAN, VA, 22102-3833, US

(21) Appl. No.: 10/501,526

(22) PCT Filed: Jan. 14, 2003
(86) PCT No.: PCT/JP03/00193

(30) Foreign Application Priority Data
Jan. 16, 2002 (JP) 2002-007016

(51) Int. Cl. G06F 17/60

(52) U.S. Cl. 705/26

(57) ABSTRACT

A method for creating a content with higher advertising function, and an appropriate device for distributing such content are disclosed. A user's PC (100) logs on to a PVad service server (200) and makes a request for distribution of a PVad (a promotion video including an advertisement element). The PVad service server (200) distributes the PVad requested. A PVad is stored by correlating with a PV-ID that is to identify an artist etc. incorporated in a promotion video, and an ad-ID that is to identify an advertised subject incorporated in the promotion video. The PVad service server (200) stores distribution logs for the PVad on a PVad view log counter database (400). An advertiser's PC (600) makes a request for a view data. The PVad service server (200) retrieves a view log from the PVad view log counter database (400) based on an ad-ID, and sends the view log retrieved as a “view data for advertiser”.

### CROSS-REFERENCE TO RELATED APPLICATIONS

The present application claims the benefit of patent application number 2002-00716, filed in Japan on Jan. 16, 2002, the subject matter of which is hereby incorporated herein by reference.

### BACKGROUND OF THE INVENTION

1. Field of the Invention

The present invention relates to a device for distributing a content with an advertisement element across a network, and a method for creating a content.

2. Description of the Related Art

The contents are utilized by the providers in order to deliver their message to the audiences. Such contents include the contents distributed via the Internet, the contents on the broadcast programs, or the like. It is common that the sponsors pay for the contents related cost in exchange for advertising their products or services by utilizing the message delivery function with the contents.

The trend has been shifting toward multi channel broadcastings in recent years as a result of introducing the Internet content distribution, the storage broadcast services, etc. in addition to the traditional TV broadcastings. In such multi channel situation, it is foreseeable that each content loses chance for exposure to the audiences than before. Therefore, the need for contents producers to create more attract contents will be rising. On the other hand, the sponsors will be required to select a content from all kinds of the contents in order to 1 of 34 achieve advertising effectiveness for their products or services. Also, there are needs for developing Web technology to effectively manage content distribution.

### SUMMARY OF THE INVENTION

The invention provides a method for creating a content with higher advertising function, and an appropriate device for distributing such content in order to suit the needs of contents creators and advertisers for sponsoring content creations.

In another aspect, the invention provides technology to create data defined with more than two individual parameters, and to obtain an individual distribution log for such data based on the individual parameter. More specifically, for data defined with several parameters, header information of the data is created by including the parameters into the header information. Therefore, at the time of distributing the data, an individual distribution log on the basis of each parameter are recorded with accuracy by utilizing the header information.

(1) A content distribution device for distributing content across a network in accordance with the present invention, wherein the content comprises a content portion and an advertisement portion;
the content distribution device comprises:
means for storing the content, wherein the content is correlated with a content portion indicator that indicates the content portion and an advertisement portion indicator that indicates the advertisement portion; and
means for distributing the content.

Users who enjoy the content distribution will see the content portion relating to the user's interest, and the same time, will be sufficiently aware of the advertisement portion. Therefore, it is expected that the content would have high advertising effect, and an advertised subject of the advertisement portion would have high sales promotion.

(3) The device in accordance with the present invention, further comprising:
means for recording a distribution log at the time of execution of the distributing means, wherein the distribution log is correlated with the content portion indicator and the advertisement portion indicator.

In the case in which more than two contents are distributed, the distribution log can be obtained based on separate viewpoint on distribution logs for content including certain content portion, or distribution logs for content including certain advertisement portion. Therefore, a producer for the content portion and a producer for the advertisement portion can easily obtain their necessary data from the distribution logs.

(5) A content distribution log recording device for recording a distribution log of a content distributed across a network in accordance with the present invention, wherein the content comprises a content portion and an advertisement portion and is correlated with a content portion indicator that indicates the content portion and an advertisement portion indicator that indicates the advertisement portion;
the content distribution log recording device comprises:
means for recording a distribution log at the time of execution of distributing the content, wherein the distribution log is correlated with the content portion indicator and the advertisement portion indicator.

In the case in which more than two contents are distributed, the distribution log can be obtained based on separate viewpoint on distribution logs for content including certain content portion, or distribution logs for content including certain advertisement portion. Therefore, a producer for the content portion and a producer for the advertisement portion can easily obtain their necessary data from the distribution logs.

(7) The device in accordance with the present invention, further comprising:
means for outputting a content portion distribution log to a content provider which provides the content portion upon receiving a request for distribution log data from the content provider, wherein the content portion distribution log is retrieved from the log recording means based on the content portion indicator; and
means for outputting an advertisement portion distribution log to an advertisement provider which provides the advertisement portion upon receiving a request for distribution log data from the advertisement provider, wherein the advertisement portion distribution log is retrieved from the log recording means based on the advertisement portion indicator.

A user providing the content portion and a user providing the advertisement portion can easily obtain necessary data only. In other words, the content distribution device does not output unnecessary distribution logs to those users. Therefore, in the case in which there are several providers for the content portion and advertisement portion, each provider's trade secret related to a distribution log can be kept secret.

In this way, access to the distribution logs can be controlled per user. That is based on the specific element of the storing content means. More specifically, the content is identified by two types of ID such as the content portion indicator and advertisement portion indicator, and those indicators are to identify each element of the content.

(9) A end device in accordance with the present invention receives the content distributed by the content distribution device.

(13) A method for developing a content together with advertisement function in accordance with the present invention, wherein the content comprises a promotional image for an artist;
the method comprising the steps of:
developing the content by incorporating an advertisement image for a product or a service into the promotional image.

Since the promotional image is more likely to be selected and seen by users who are interested in the artist appeared in the promotional image, the users are expected to be sufficiently interested in the advertisement image included in the promotional image. Therefore, since it is highly possible that the users are aware of the advertisement image, advertising effect of the advertised subject would be increased.

(14) A method for compensation allocation for a product placement content in accordance with the present invention, wherein the content comprises a promotional image for an artist and an advertisement image for a product or a service incorporated into the promotional image;
the method comprising the steps of:
obtaining viewing logs; and
paying the compensation from an advertisement provider to a content provider on the basis of the viewing logs.

The provider of the advertisement image utilizing the product placement (which is a method to integrate an advertiser's product etc. into the movies, the TV shows, etc.) can conduct precise transactions based on accomplishments and/or results since the provider pays the compensation to the provider of the promotional image on the basis of the viewing log.

The definitions of the terms used herein will be explained.

The term “content” in the present invention includes an image information such as a freeze frame image and a moving image, sound information, or combination information of image information and sound information. More specifically, the term “content” includes a providing subject at a certain unit through the use of the TV broadcasting, the digital broadcasting, the storage broadcasting, the distribution via the Internet (which includes the Internet connection using the ADSL or the Cable TV), or the like. For example, the term “content” includes information that is provided through the use of the digital technology etc., and the information includes a commercial message (CM), an advertisement, a movie, a short movie, a drama, a promotion video, a live broadcast or a taped broadcast for a theatrical or a sport, or an educational program broadcast.

The features of the present invention can be described broadly as set forth above. The structures and characters of the present invention will be apparent from the following detailed description of the invention together with those features, effects, and drawings.

### BRIEF DESCRIPTION OF THE DRAWINGS

FIG. 1 shows an overall of a PVad (Promotion video advertisement) service system.

FIG. 2 illustrates a block diagram of a user's PC.

FIG. 3 illustrates a block diagram of an advertiser's PC.

FIG. 4 illustrates a block diagram of a PVad service server.

FIG. 5 illustrates a configuration of a PVad database.

FIG. 6 illustrates a configuration of a PVad view log counter database.

FIG. 7 is a flowchart showing a PVad distribution service.

FIG. 8A illustrates an example of a main menu screen.

FIG. 8B illustrates an example of a PVad screen.

FIG. 9 is a flowchart showing a PVad view data service.

FIG. 10A illustrates an example of a ID/Password entry screen.

FIG. 10B illustrates an example of a ID/Password verification screen.

FIGS. 11A, 11B, and 11C illustrate an example of a view data screen for an advertiser use.

FIG. 12 illustrates an example of a view data screen for a record company use.

FIG. 13 shows a system architecture of the PVad service system.

### DESCRIPTION OF THE PREFERRED EMBODIMENTS

Embodiments according to the present invention will be described below by illustrating a promotion video (PV) as one embodiment of the term “content” in the present invention.

Generally, the promotion video is produced in order to advertise an artist's musical composition to audiences. One aspect of the embodiments, the promotion video includes an advertisement image. More specifically, for instance, the promotion video is produced to include a scene of which an artist is drinking a beverage being advertised during the artist's performance. With such content, it is expected that advertising effect of the advertised subject would be remarkably increased. Since the artist promotion video is commonly seen by audiences who are interested in the artist, the audiences are expected to be interested in the advertised good or service incorporated in the promotion video. One feature of the embodiments is to provide a method for creating high advertising effect contents. Such contents will be explained as “promotion video advertisement” or “PVad” as an abbreviation. In addition, embodiments provide Web technology to effectively manage the content distribution.

In the embodiments herein, a PVad service system will be explained. In the PVad service system, a PVad service server, which is as the “content distribution device”, provides PVad distribution services for user's personal computers. As above-mentioned, it is expected that advertising effect of the advertised products or services would be increased by utilizing the unique contents, the PVad.

Table of Contents for the Embodiments

1. An Overview of System
2. Devices
3. Embodiments and Structures Corresponding to Terms in the Claims
4. Processing of the System
4-1. PVad Distributing Service
4-2. PVad View Data Service
5. Advantages of the Embodiments
6. Other Embodiments.
   1. An Overview of System

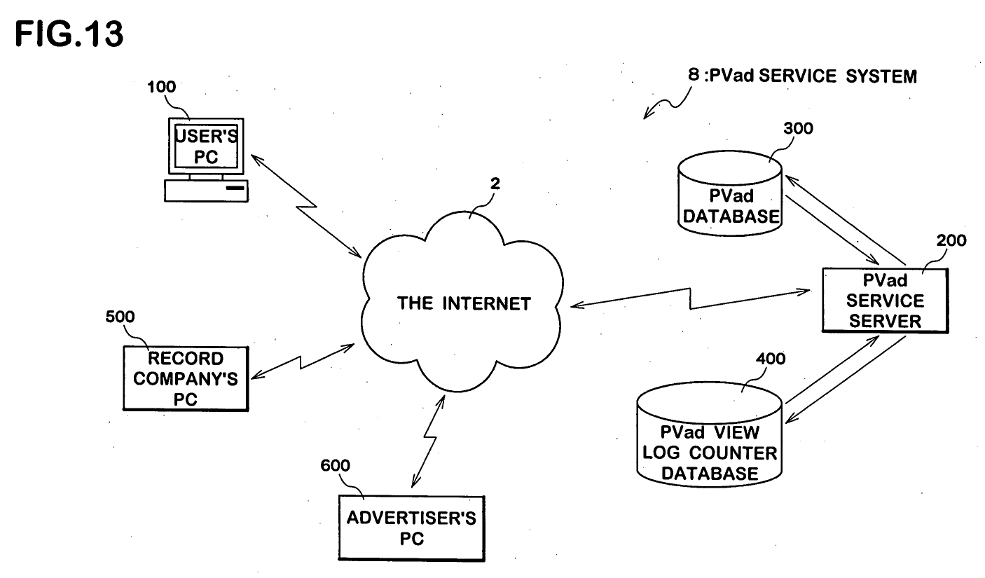

FIG. 13 shows a system architecture of a PVad service system 8. The PVad service system 8 includes a user's personal computer (PC) 100 used by a user, a record company's PC 500 used by a record company, an advertiser's PC 600 used by a advertiser, and a PVad service server 200 supervised by a business owner of the PVad service. The user's PC 100, the record company's PC 500, the advertiser's PC 600, and the PVad service server 200 can be connectable to each other by the Internet 2. The PVad service server 200 has access to a PVad database 300 and a PVad view log counter database 400. The PVad service server 200 provides PVad distributing services etc. via an Internet web site (e.g. a portal site).

The PVad database 300 is to store PVad data and relevant information regarding the PVad data. The PVad view log counter database 400 is to store view log data or distribution log data for PVads distributed to users.

The PVad database 300 and the PVad view log counter database 400 are stored on a hard disk in the PVad service server 200, or stored in a server device (not shown) other than the server 200.

2. Devices

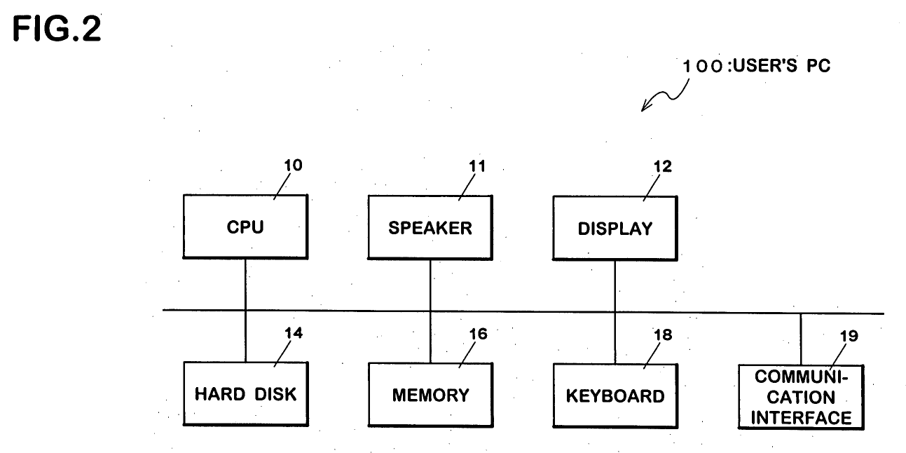

FIG. 2 illustrates a hardware configuration example of the user's PC 100 by use of a central processing unit (CPU). The user's PC 100 includes a CPU 10, a speaker 11, a display 12, a hard disk 14, a memory 16, a keyboard 18, and a communication interface 19 for connecting to the Internet 2. The CPU 10 controls operations of the user's PC 100. The memory 16 acts as a storage area for data processing of the CPU 10. The hard disk 14 stores a computer program for the CPU 10 to execute and a browser program for browsing web pages. Inputting information from the keyboard 18 is inputted to the CPU 10, and the CPU 10 generates display information and sound information for the display 12 and the speaker 11 to output.

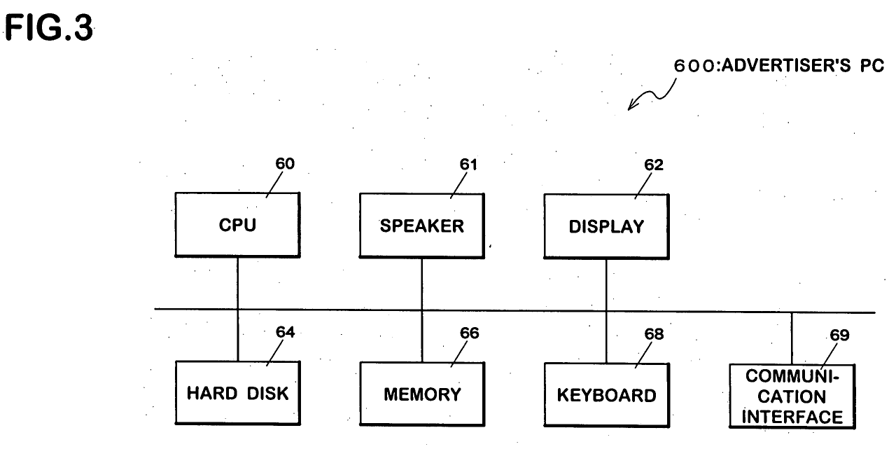

FIG. 3 illustrates a hardware configuration example of the advertiser's PC 600 by use of a central processing unit (CPU). The advertiser's PC 600 includes a CPU 60, a speaker 61, a display 62, a hard disk 64, a memory 66, a keyboard 68, and a communication interface 69 for connecting to the Internet 2. Each hardware has identical functions with same hardware of the user's PC 100. A hardware configuration of the record company's PC 500 is same as the advertiser's PC 600.

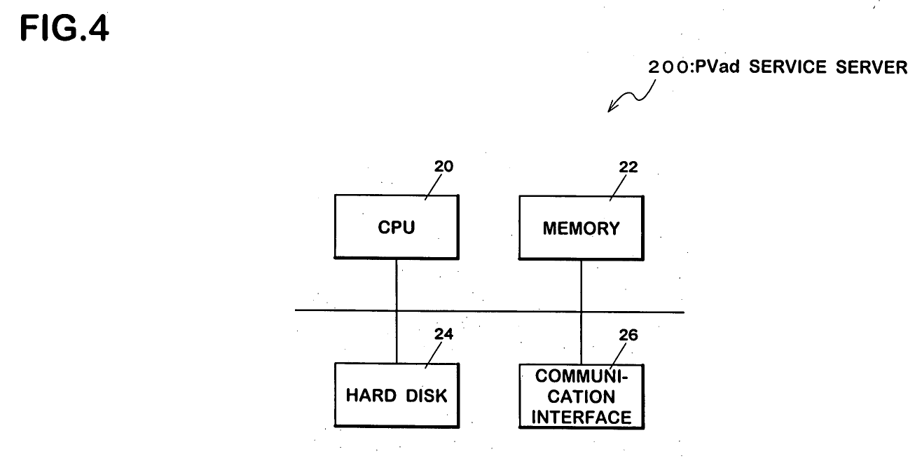

FIG. 4 illustrates a hardware configuration example of the PVad service server 200 by use of a central processing unit (CPU). The PVad service server 200 includes a CPU 20, a hard disk 24, a memory 22, and a communication interface 26 for connecting to the Internet 2. The hard disk 24 stores a PVad service program.

In the embodiments, an example of operation system of the user's PC 100, the advertiser's 600, and the PVad service server 200 is Microsoft's Windows™ XP, NT, 2000, etc. In the embodiments, the computer program works with the operation system. For alternative embodiments, the computer program works without the operation system.

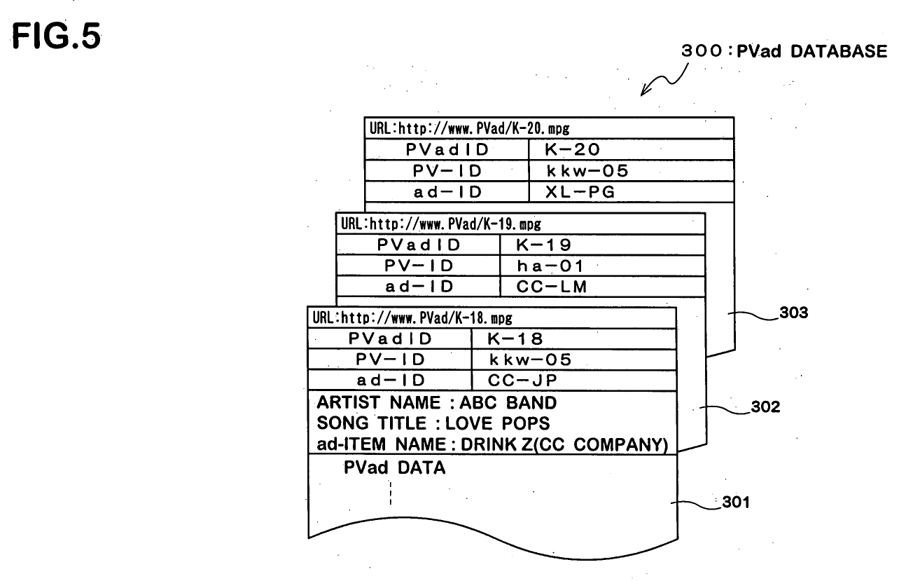

FIG. 5 illustrates a configuration example of the PVad database 300. The PVad database 300 stores information related to PVad such as “Artist Name”, “Song Title”, “ad-item name” that is to identify brand name, service name, or the like incorporated into a PVad by the advertiser, and “PVad data” that is a PVad promotion video itself. Further, the PVad database 300 stores header information including a uniform resource locator (URL) which is a website address for the PVad data (MPG format etc.), “PVad-ID” as an identifier of a PVad promotion video, “PV-ID” as an identifier of an artist name and song title, and “ad-ID” as an identifier of an advertiser and ad-item name.

More specifically, the main of the PV-ID (e.g. “kkw” for the data 301 in FIG. 5) is the identifier (an embodiment of the “content portion provider indicator”) of the artist, and the sub number of the PV-ID (e.g. “05” for the data 301) is the identifier of the song title. On the other hand, the main number of the ad-ID (e.g. “CC” for the data 301) is the identifier (an embodiment of the “advertisement portion provider indicator) of the advertiser, and the sub number of the ad-ID (e.g. “JP” for the data 301) is the identifier of the ad-item.

One of the feature of the PVad database 300 is that the PVad stored in the database 300 is identified by not only the PVad-ID but also the PV-ID or ad-ID that is to identify the individual element composing the PVad. The PVad database 300 stores those identification such as the data 301, the data 302, the data 303, etc. per the PVad promotion video.

The configuration of the PVad database 300 is not limited to above-mentioned. For alternative embodiments, data corresponding to the header information (e.g. PVad-ID) is stored independently as a table data (not shown), and PVad data is stored on a database (not shown) aside from the table data. In that case, each information on the table data is correlated with the PVad data by a link information.

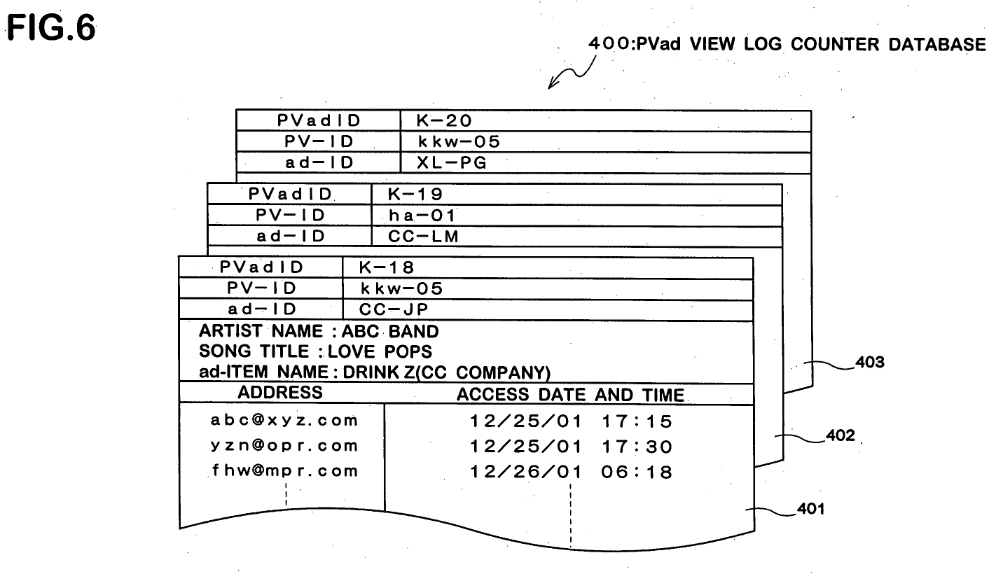

FIG. 6 illustrates a configuration example of the PVad view log counter database 400. The PVad view log counter database 400 stores “PVad-ID.” as an identifier of a PVad promotion video, “PV-ID” as an identifier of an artist name and song title, “ad-ID” as an identifier of an advertiser and ad-item name, “Address” to identify a user who received PVad distributed, and “access date and time” from the user. Relation between the main number and the sub number for each ID is same as the above-mentioned in FIG. 5. The PVad view log counter database 400 stores above-mentioned identification such as the data 401, the data 402, the data 403, etc. per the PVad promotion video.

3. Embodiments and Structures Corresponding to Terms in the Claims

Embodiments and structures corresponding to the terms used in the claims will be explained as follows.

The “content” corresponds to a PVad promotion video distributed to the user PC from the PVad service server 200. The “content portion” corresponds to a promotion video image. The “advertisement portion” corresponds to an advertisement image. The “content distribution device” corresponds to the PVad service server 200 shown in FIG. 13. The “network” corresponds to the Internet 2 shown in FIG. 13.

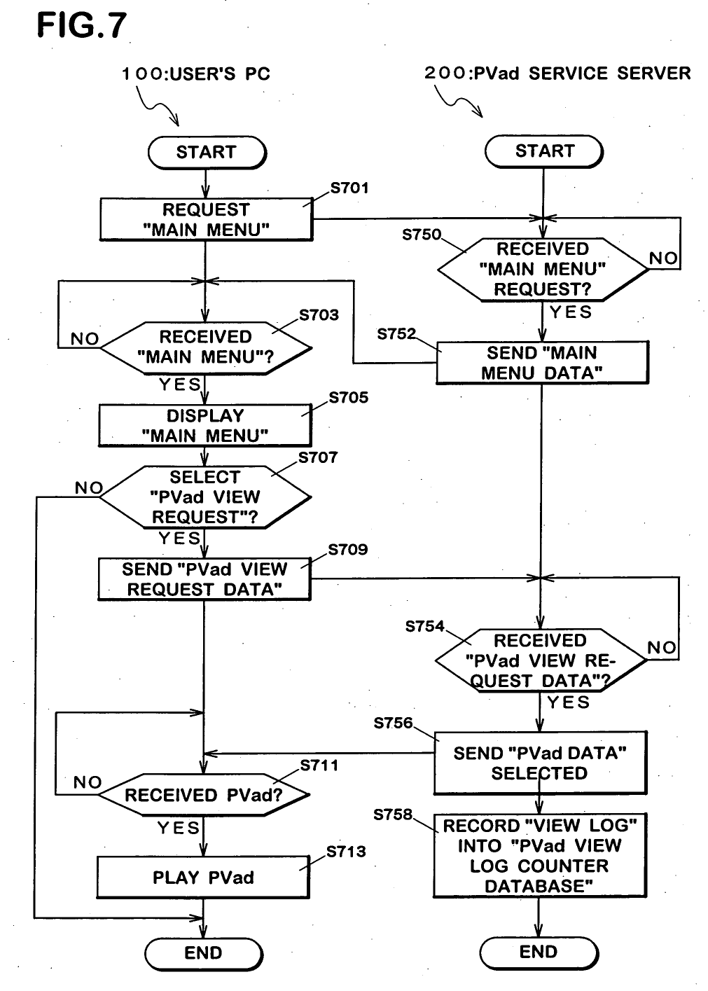

The “content portion indicator” corresponds to the PV-ID stored on the PVad database 300 shown in FIG. 5. The “advertisement portion indicator” corresponds to the ad-ID stored on PVad database 300 shown in FIG. 5. The “content storing means” corresponds to the CPU 20 of the PVad service server 200 storing PVads on the PVad database 300. The “content distributing means” corresponds to the CPU 20 sending a PVad at step 756 in FIG. 7.

The “distribution log recording means” corresponds to the CPU 20 storing a PVad view log on the PVad view log counter database 400 at step 758 in FIG. 7. The “distribution log data” corresponds to data stored on the PVad view log counter database 400 by the CPU 20 at step 758 in FIG. 7.

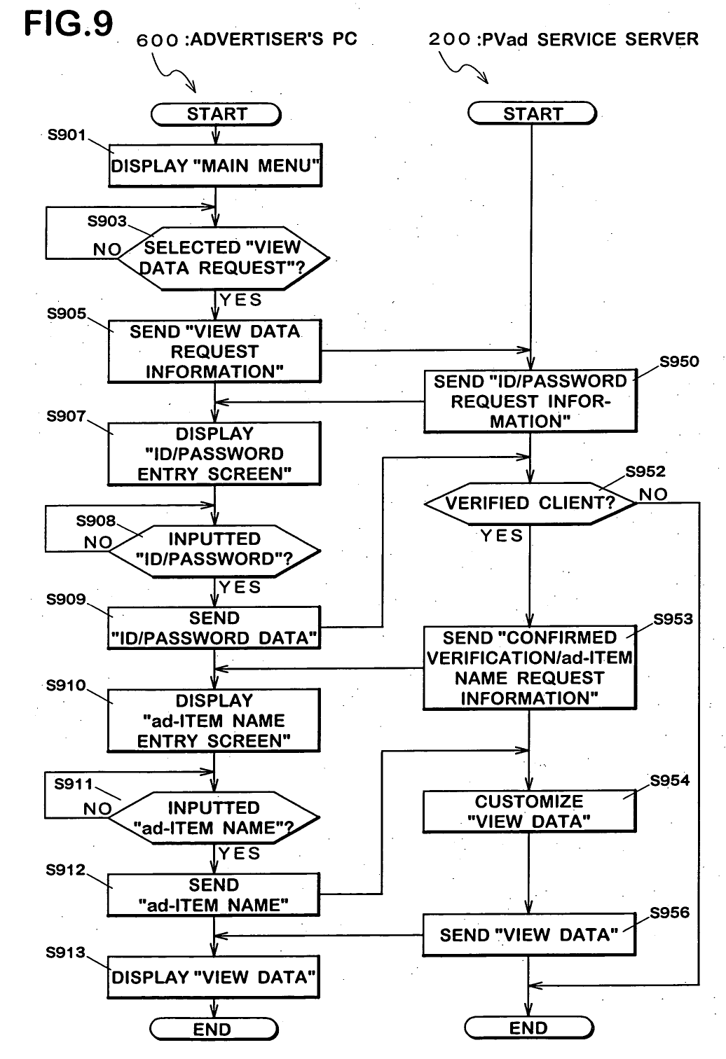

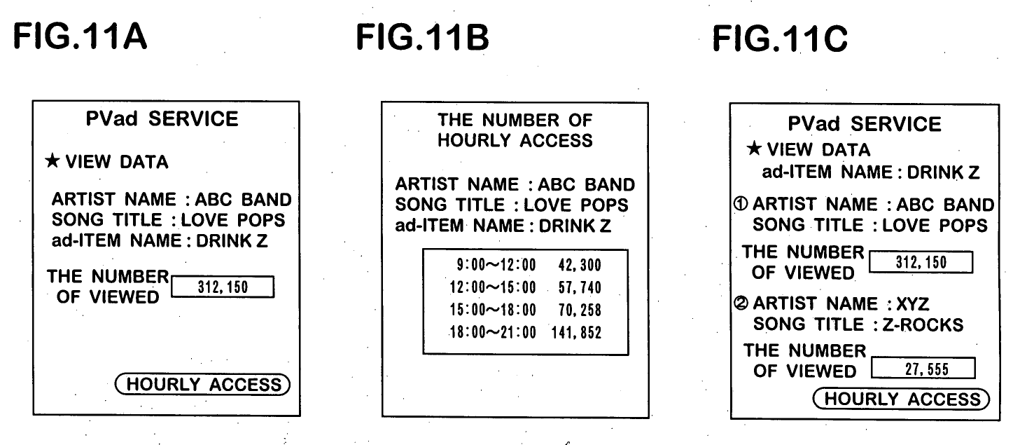

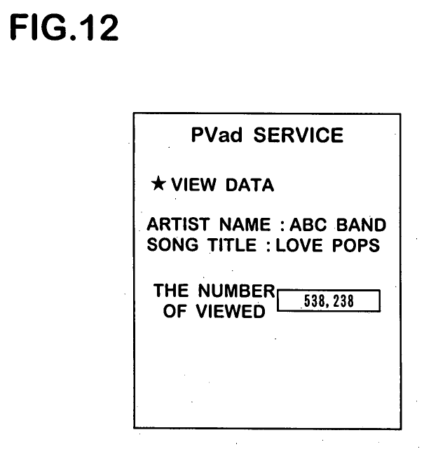

The “content portion distribution log outputting means” corresponds to the CPU 20 retrieving view data for the record company PC 500, and sending the view data to the record company PC 500. The “content portion distribution log” corresponds to a view data for the record company's PC shown in FIG. 12. The “advertisement portion distribution log outputting means” corresponds to the CPU 20 retrieving a view data for the advertiser's PC 600, and sending the view data to the advertiser's PC 600 at step 954 and 956 in FIG. 9. The “content portion distribution log” corresponds to a view data for the advertiser's PC shown in FIG. 11.

The “content portion indicator recording unit” corresponds to columns storing the PV-IDs in the PVad database 300 shown in FIG. 5. The “advertisement portion indicator recording unit” corresponds to columns storing the ad-IDs in the PVad database 300 shown in FIG. 5. The “content indicator recording unit” corresponds to columns storing PVad-IDs in the PVad database 300. The “end device” corresponds to the user's PC 100.

4. Processing of the System

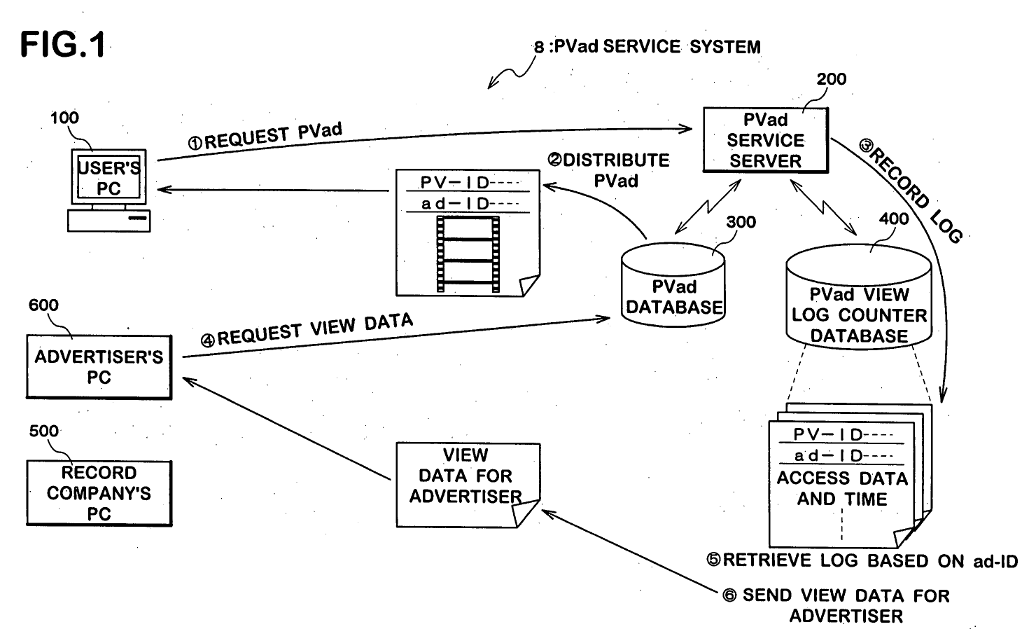

FIG. 1 shows an overall processing of the PVad service system. The user's PC 100 logs on to the PVad service server 200 and makes a request for distribution of a PVad in accordance with user operation (step 1). The PVad service server 200 distributes the PVad requested to the user's PC 100. (step 2). PVad promotion videos are stored by correlating with PV-ID that is to identify an artist and musical composition incorporated in the promotion video, and ad-ID that is to identify an advertised product or service incorporated in the promotion video. The PVad service server 200 stores distribution logs for the PVad on the PVad view log counter database 400 (step 3). The distribution log such as an “access date and time” per PVad distributed is stored. The processing above-mentioned is an overall of the PVad distributing processing.

The following is an overall processing of a PVad view data service processing. The PVad view data service is to notify an advertiser and record company of specific data related to the number of viewed for their PVad. The advertiser's PC 600 logs on to the PVad service server 200 and makes a request for a view data in accordance with user operation (step 4). The PVad service server 200 retrieves a view log from the PVad view log counter database 400 based on the ad-ID (step 5). Only the view log for the logged on advertiser is selectively retrieved with that processing. The PVad service server 200 sends the view log retrieved, which is as a “view data for advertiser”, to the advertiser's PC 600 (step 6).

As explained above, the PVad service system distributes high advertising effect PVads to users. Furthermore, record companies and advertisers who involved the PVad production can obtain specific view data for the PVad.

The detailed of above-mentioned processing, for PVad distribution service stage and PVad view data service stage, will be explained below.

4-1. PVad Distribution Service

The PVad distribution service includes a process that the PVad service server 200 distributes a PVad on demand of the user's PC 100 owned by user. A processing of the PVad distribution service will be explained by a program flowchart shown in FIG. 7.

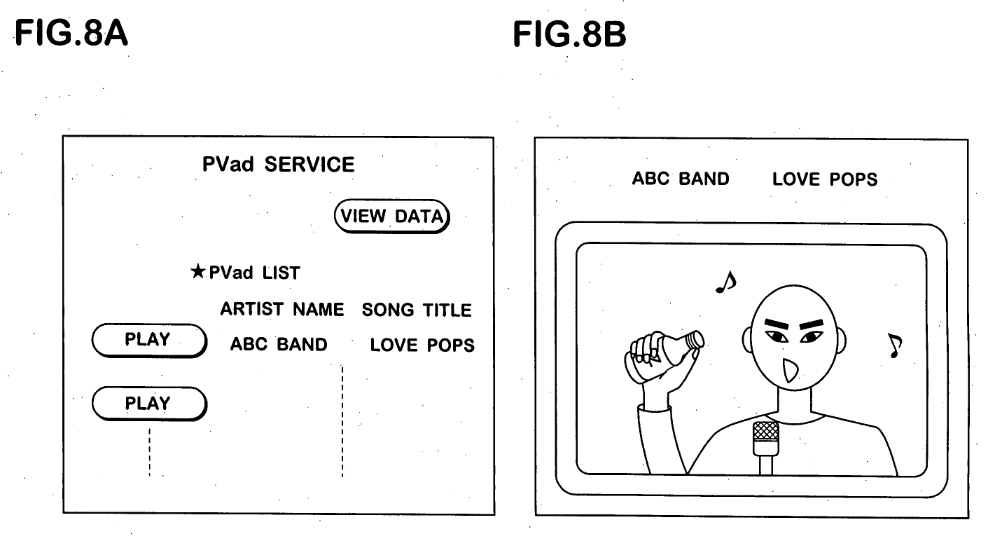

The CPU 10 of the user's PC 100 logs on to the PVad service server, and sends a request for “MAIN MENU” to the PVad service server 200 (step 701 at FIG. 7). The CPU 20 of the PVad service server 200 determines whether the “MAIN MENU” request was received (step 750). If the request was received, then the CPU 20 sends a main menu screen data (step 752). The CPU 10 of the user's PC 100 determines whether the main menu screen data was received (step 703). If the main menu screen data was received, the CPU 20 displays the “MAIN MENU” on the display 12 based on the main menu screen data (step 705). FIG. 8A illustrates an example of the main menu screen. The main menu includes the PVad list which is identified with the artist names, the song titles, etc.

The CPU 10 of the user's PC 100 determines whether a “PVad view request” was selected according to the user operation (step 707). The PVad view request is executed by clicking on the “PLAY” button in the main menu shown in FIG. 8A. More specifically, the CPU 10 accesses the URL of PVad data selected (refer to FIG. 5) in accordance with the clicking. If the PVad view request was selected, the CPU 10 sends the PVad view request data to the PVad service server 200 (step 709). The PVad view request data is to identify a specific PVad stored on the PVad database 300 shown in FIG. 5. More specifically, the PVad view request data includes the URL of the PVad data. The CPU 20 of the PVad service server 200 determines whether the PVad view request data was received from the user's PC 100 (step 754). If the PVad view request data was received, the CPU 20 sends the PVad data selected to the user's PC 100 (step 756).

The CPU 10 of the user's PC 100 determines whether the PVad data was received from the PVad service server 200 (step 711). If the PVad data was received, the CPU 10 plays the PVad promotion video based on the PVad data (step 713), and completes its tasks after ending the video playing. FIG. 8B illustrates an example of the PVad promotion video playing screen. After step 756, the CPU 20 of the PVad service server 200 records a view log into the PVad view log counter database 400 (step 758) based on the PVad data sent, and completes its tasks.

FIG. 6 illustrates a configuration example of the PVad view log counter database 400. As shown in FIG. 6, the PVad view log counter database 400 stores, per PVad promotion video, a PVad-ID identifying a PVad, PV-ID identifying an artist and musical composition, and an ad-ID identifying an advertised subject. At the time of execution of sending a PVad data at step 756, the CPU 20 records, as a view log, an “address” of a user's PC 100 that received a PVad data and “access date and time” from the user's PC 100.

4-2. PVad View Data Service

The PVad view log counter database 400 will store more than two view logs as a result of continuing PVad distributing services described above. The PVad view log data service includes a process that the PVad service server 200 releases view logs on demand of client machines. A processing of the PVad view log data service will be explained by a program flowchart shown in FIG. 9. In FIG. 9, the advertiser's PC 600 is illustrated as an example of the client machine. The following process is applicable in the case of the record company's PC 500 logs on to the control server 100, except descriptions of view logs.

The CPU 60 of the advertiser's PC 600 logs on to the PVad service server 200, and displays the “MAIN MENU” on the display 62 (refer to FIG. 8A) (step 901). The CPU 60 determines whether a “view data request” was selected according to a user (e.g. responsible person for advertisement production) operation (step 903). The view data request is executed by clicking on the “VIEW DATA” button in the main menu shown in FIG. 8A. If the view data request was selected, the CPU 60 sends view data request information to the PVad service server 200 (step 905). The CPU 20 of the PVad service server 200 receives the view data request information, and sends ID/Password request information (step 950).

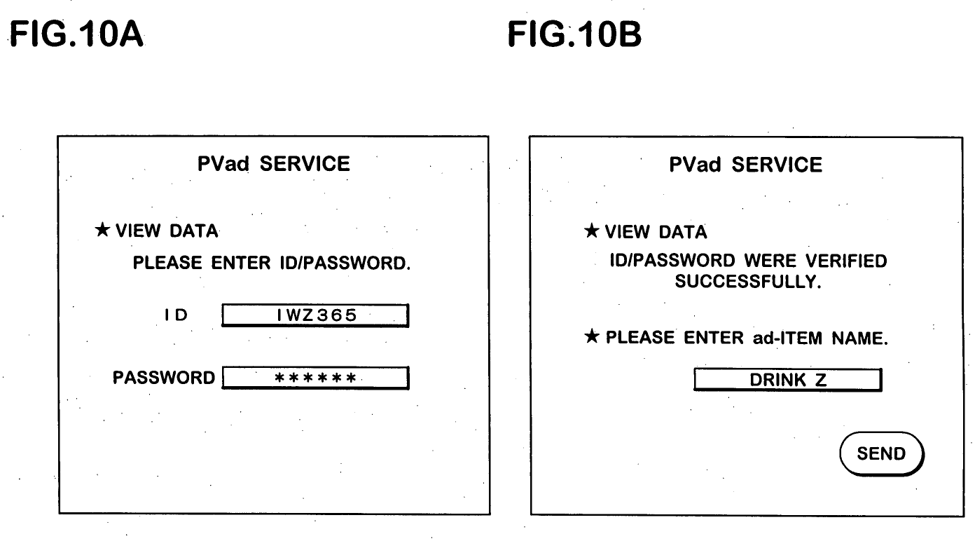

The CPU 60 of the advertiser's PC 600 receives the ID/Password request information, and displays “ID/Password entry screen” on the display 62 based on the request information (step 907). FIG. 10A illustrates an example of the ID/Password entry screen. The CPU 60 determines whether the ID/Password was inputted in accordance with the user operation (step 908). If the ID/Password was inputted, the CPU 60 sends the ID/Password to the PVad service server 200 (step 909). The CPU 20 of the PVad service server 200 receives the ID/Password, and determines whether the client was verified (step 952). That client verification can be executed by verifying that the ID/password is identical to pre-set ID/Password for each advertiser's PC 600 stored on the hard disk 24 in the PVad service server 200.

If the client was verified, the CPU 20 of the PVad service server 200 sends a confirmed verification and ad-item name request information to the advertiser's PC 600 (step 953). The CPU 60 of the advertiser's PC 600 receives the information, and displays “ad-item name entry screen” on the display 62 (step 910). FIG. 10B illustrates an example of the ad-item name entry screen.

The CPU 60 determines whether an ad-item name was inputted (step 911). If an ad-item name was inputted, the CPU 60 sends the ad-item name to the PVad service server 200 (step 912). That determination of the CPU 60 can be executed based on whether or not the user clicks the “SEND” button shown in FIG. 10B.

The CPU 20 of the PVad service server 200 receives the ad-item name, and customizes a view data for the advertiser's PC 600, which is requesting a view data (step 954). The CPU 20 sends the view data customized to the advertiser's PC 600, and completes its tasks (step 956). The CPU 60 of the advertiser's PC 600 displays the view data received on the display 62, and completes its tasks (step 913). If the client verification fails at step 952, the CPU 20 can send en error message about the verification fail after a set number of failed ID/Password verification attempts.

The CPU 20 executes the processing for modifying a view data to be an advertiser's use (refer to step 954 in FIG. 11) by accessing the PVad view log counter database shown in FIG. 6, retrieving data that correlated with ad-item name (or ad-ID) specified, and performing a statistical analysis based on “access date and time” and the number of count, which are included in the data retrieved.

More specifically, the CPU 20 receives the ad-item name sent at step 912 in FIG. 9, and retrieves data (e.g. the “data 401” in FIG. 6) including the ad-item name (e.g. “DRINK Z”) from the PVad view log counter database 400. The CPU 20 performs a statistical analysis based on “access date and time” and the number of count which are recorded in the data 401, and obtains a view data requested by the advertiser's PC 600.

FIG. 11 illustrates an example of a view data screen customized for the advertiser's PC 600. FIG. 11A illustrates a view data about a certain PVad that including certain product advertisement provided by an advertiser of advertiser's PC 600. For the purpose of illustrations, the following will be explained assuming that the advertiser provides the advertisement of ad-item name “DRINK Z” in relation to the PV (promotion video) song title of “LovePops” by artist name of “ABC BAND”. As shown in FIG. 11A, the advertiser's PC 600 can check the number of viewed related to the PVad. FIG. 11B illustrates a view data screen and the data is obtained by tabulating the number of viewed shown in FIG. 11A on a time period basis. The view data screen is displayed in accordance with a clicking operation on the “HOURLY ACCESS” button in the screen shown in FIG. 11A. FIG. 11C illustrates an example of a view data screen when an advertiser provides the advertisement of ad-item name “DRINK Z” to more than two PVs (promotion videos).

More specifically, when an ad-item is provided to more than two PVs as above-mentioned, more than two PVads which are stored on the PVad database 300 are correlated with same ad-ID. That situation can arise because the PVad in the embodiments are created with combination of a promotion image for artist's musical composition and a advertisement image. Therefore, aside from the case of more than two PV-IDs are correlated with same ad-ID as above-mentioned, more than two ad-IDs can be correlated with same PV-ID. For example, for certain promotion video of artist's musical composition, more than two promotion video variations can be created with different advertised subject (refer to the data 401 and 403 shown in FIG. 6, which have same PV-ID.). Moreover, a PVad promotion video can be created by including not only one advertised subject but also more than two advertised subjects in a promotion video image.

FIG. 12 illustrates an example of a view data screen customized for the record company's PC 500. For the record company's PC 500, the PVad service server 200 executes similar processing as the PVad view data service shown in FIG. 9. The record company can check the number of 19 of 34 viewed for the PVad for song title of “LovePops” by artist name of “ABC BAND”. The CPU 20 executes the processing for modifying a view data to be a record company's use by accessing the PVad view log counter database shown in FIG. 6, retrieving data that correlated with specific song title (or specific artist name, or PV-ID), and performing a statistical analysis based on the “access date and time” and the “number of count” which are included in the data retrieved.

More specifically, the CPU of the record company's PC 500 sends a “song title” instead of an ad-item name at step 912 in FIG. 9. The CPU 20 of the PVad service server 200 retrieves data (e.g. the data 401 and 403 in FIG. 6) including the song title (e.g. “LovePops”) from the PVad view log counter database 400. The CPU 20 performs a statistical analysis based on the “access date and time” and the “number of count” which are recorded in the data 401, and obtains the view data requested by the record company's PC 500.

The customizing processing at step 954 in FIG. 9 is executed by obtaining a view data based on an ad-item name or song title. That customizing processing is not limited to the embodiment described above. For alternative embodiments, a view data can be obtained based on an advertiser name or artist name. More specifically, the advertiser's PC 600 sends a main number of a PV-ID (i.e. an identifier of an advertiser) instead of an ad-item name. Then, the CPU 20 of the PVad service server 200 retrieves a data (e.g. the data 401 and 402 in FIG. 6) including the main number received (e.g. “CC”) from the PVad view log counter database 400. The CPU 20 performs a statistical analysis based on the “access date and time” and the “number of count” which are recorded in the data 401 and 402, and obtains the view data requested by the advertiser's PC 600. With that processing, the advertiser can obtain a view data related to all the ad-items that are provided by the advertiser.

The invention includes a technology to obtain an individual distribution log for data defined with more than two individual parameters based on the individual parameter as the processing shown at step 954. More specifically, for data defined with different parameters, header information (i.e. PV-ID and ad-ID) which includes the parameters is recorded with the data. Also, the invention includes a technology to, at the time of distributing the data, efficiently record an individual distribution log. (i.e. a view data customized for an advertiser's PC 600-use or record company's PC 500-use) on the basis of each parameter by utilizing the header information.

5. Advantages of the Embodiments

In the embodiments, a user enjoying the PVad promotion video distributing service will see the promotion image relating to the user's interest, and at the same time, will be sufficiently aware of the advertisement image included in the promotion image. This may be because that the promotion video is commonly selected and seen by users who are interested in an artist appeared in the video, the users are expected to be sufficiently interested in the advertisement image included in the promotion image. Therefore, it is expected that an advertising effect of the advertising image such as products or services would be increased. Also, the advertiser can enhance an effectiveness of sales promotion for the products etc.

In the embodiments, for data defined with different parameters, header information (i.e. the PV-ID and the ad-ID) including the parameters is recorded. Therefore, the embodiments provides a Web technology to efficiently record an individual distribution log (i.e. a view data customized for an advertiser's PC 600-use or record company's PC 500-use) on the basis of each parameter by utilizing the header information.

Conventionally, an advertiser has taken out an advertisement for products etc. in a commercial or banner advertising etc. regarding a promotion video in TV broadcasting or the Internet distribution. That commercial or banner advertising is independent advertisement information aside from the promotion video. Therefore, users who are interested in the promotion video are not always come into contact or aware of the advertisement information. On the other hand, since the PVad promotion video of the embodiments includes an advertisement image in a promotion image, users who are interested in the promotion video are expected to be actively aware of an advertised subject in the advertisement image. An advertisement image can include the scene of an artist appeared in a PVad actively enjoying certain product or service in order to increase the advertisement function.

In the embodiments, as shown in FIG. 6, the PVad view log counter database 400 stores view logs with two types of Ids and the IDs are a PV-ID identifying an artist and music composition, and an ad-ID identifying an advertised subject. That allows the view log to be recorded based on separate viewpoint on distribution logs results for certain artist/music composition's PVad, or distribution logs results for certain advertised subject's PVad. Therefore, necessary data can be easily obtained by a record company involved in producing promotion images and an advertiser involved in producing advertisement images respectively.

In the embodiments, the PVad service server 200 verifies a client accessed (i.e. an advertiser's PC 600 or record company's PC 500) with a ID/Password (refer to step 952 in FIG. 9), and sends a view data only for the client's use (refer to step 954 and 956 in FIG. 9). The PVad service server 200 does not send unnecessary view data to clients. Therefore, each client's trade secret related to a view data can be kept secret. In this way, a view data access can be controlled per client. This is because the embodiments adopt a unique content identifying method. More specifically, a content (i.e. the PVad) is identified by two types of IDs such as the PV-ID and ad-ID and the IDs are to identify each element of the content. For alternative embodiments, depending on a specific PVad service concept, customizing a view data for a specific client may not be necessary. In that case, the processing of step 954 in FIG. 9 can be omitted. If the access controlling for view data is not required, the client verification processing with the ID/Password can be omitted (refer to step 950, 907, 909, 911, and 952 in FIG. 9).

Costs incurred by clients such as an advertiser or record company can be easily determined based on view logs since the clients can obtain the view logs from the view data service. For example, two sides between an advertiser and record company adjust a certain view rate (e.g. a view price per one view log), and then, the advertiser pays the record company for an achieved view log compensation which can be calculated by multiplying the view rate by the number of view log obtained (This step corresponds to “paying the compensation from an advertisement provider to a content provider on the basis of the viewing log”). If that compensation determination method is applied, it is expected that record companies would create view-log-getting PVad(s), and advertisers would select such record companies in order to advertise their products etc. If a record company are selected by more advertisers, the record company will receive more achieved view log compensation. Accordingly, the company will create high-quality PVad, and an advertising effect for products etc. will be increased. In any event, one reason that embodiments can include above-mentioned advantages is that the embodiments adopt a unique step, in other words, the clients can obtain view logs from the view data service.

Clients can analyze an audience ratings (e.g. viewing rates) on promotion images and/or advertisement images based on the view data obtained from the view data service. Therefore, the clients can utilize the view data for developing high audience rating PVad producing strategy. In the case in which each client obtain the number of hourly access shown in FIG. 11B, the client can acquire more detailed audience rating.

For alternative embodiments, at the time of execution of storing a view log on the PVad view log counter database 400, the CPU 20 of the PVad service server 200 records user's profile such as gender, age, postal address, postal address, etc. The view data provided by the view data service will be an in-depth data with that processing. More specifically, for example, if certain advertised product included in a PVad is to target certain age group, the precision of PVad evaluation will be improved by extracting a view log portion of the age group from the number of view log and analyzing the log portion extracted. Marketing activities using the PVad(s) will be effective with the in-depth view log data. Recording the user's profile can be executed by requesting user's profiles entry as a user registration step in the PVad distribution service.

In the embodiments, the CPU 20 of the PVad service server 200 sends a view data on demand of the advertiser's PC 600 etc. For alternative embodiments, the CPU 20 accesses the PVad view log counter database 400, and sends certain view data (e.g. e-mail sending) every specified view count number or every specified period.

6. Other Embodiments

6-1. System Configuration Variations

In the embodiments, the user's PC 100 is illustrated as a user's end device. For alternative embodiments, a personal digital assistant (PDA), mobile phone, etc. (not shown) can be used as the user's end device.

In the embodiments, the PVad service server 200 records a view log into the PVad view log counter database 400 (refer to step 758 in FIG. 7). For alternative embodiments, a separate server machine (not shown. This machine corresponds to “content distribution log recording device”) can be installed to record the view log. In that case, the server machine obtains information about a PVad distributed (e.g. the PVad-ID, PV-ID, ad-ID, access date and time, etc.) on the Internet.

In the embodiments, the Internet service is illustrated for an administration form of the PVad service. For alternative embodiments, a storage broadcast, a hard disk broadcast, an interactive broadcast, etc. (not shown) can be used for an administration form of the PVad service. The PVad view log will be obtained by a telephone line etc (not shown).

6-2. Program Executions

In the embodiments, computer programs for the CPU 10 of the user's PC 100, computer programs for the CPU 20 of the PVad service server 200, and computer programs for the CPU 60 of the advertiser's PC 600 are stored on the hard disk 14, the hard disk 24, and the hard disk 64, respectively. Those computer programs can be installed from installation CD-ROMs (not shown). For alternative embodiments, the programs can be installed by a computer-readable storage media such as a flexible disk (FD), or IC card (not shown). Alternatively, the programs can be downloaded to the devices via the communications lines. The programs are installed on the devices from the CD-ROMs, and the devices execute the programs installed. For alternative embodiments, the devices can directly execute programs stored on the CD-ROMs.

Computer-executable programs used in the embodiments include a program to be executable just after installation, a program needed to be converted to another format (e.g. decompressing compressed data), and a program to be executable with a module.

In the embodiments, each process is executed by the CPU and the computer program. For alternative embodiments, a part of the functions or all of the functions can be accomplished with a hardware logic. (logic circuit) (not shown).

6-3. Administration Form Variations of a PVad Matching System

In the embodiments, the PVad service system 8 includes a record company's PC 500 used by record company, an advertiser's PC 600 used by advertiser, a PVad service server 200 supervised by business owner of the PVad service, and a user's personal computer (PC) 100 used by user. The system configuration is not limited above-mentioned.

For alternative embodiments, instead of the promotion video as a “promotional image” used herein, a movie or drama can be applied. In that case, the record company's PC 500 is supervised by a movie company or entertainers office etc. Also, an actor or entertainer correspond to an “artist” used herein.

A general description of the present invention as well as preferred embodiments of the invention has been set forth above. It is to be expressly understood, however, the terms described above are for purpose of illustration only and are not intended as definitions of the limits of the invention. Those skilled in the art to which the present invention pertains will recognize and be able to practice other variations in the system, device, and methods described which fall within the teachings of this invention. Accordingly, all such modifications are deemed to be within the scope of the invention.

1. A content distribution device for distributing a content across a network, wherein the content comprises a content portion and an advertisement portion;
the content distribution device comprises:
means for storing the content, wherein the content is correlated with a content portion indicator that indicates the content portion and an advertisement portion indicator that indicates the advertisement portion; and
means for distributing the content.

2. A computer program for a content distribution device that distributes a content across a network, wherein the content comprises a content portion and an advertisement portion;
the program is implemented in a computer and capable of causing the computer perform:
means for storing the content, wherein the content is correlated with a content portion indicator that indicates the content portion and an advertisement portion indicator that indicates the advertisement portion; and
means for distributing the content.

3. The device according to claim 1, further comprising:
means for recording a distribution log at the time of execution of the distributing means, wherein the distribution log is correlated with the content portion indicator and the advertisement portion indicator.

4. A content distribution device for distributing a content across a network, wherein the content comprises a content portion and an advertisement portion;
a central processing unit (CPU) of the content distribution device is to execute the procedures of:
storing the content, wherein the content is correlated with a content portion indicator that indicates the content portion and an advertisement portion indicator that indicates the advertisement portion;
distributing the content; and
recording a distribution log at the time of execution of distributing the content, wherein the distribution log is correlated with the content portion indicator and the advertisement portion indicator.

5. A content distribution log recording device for recording a distribution log of a content distributed across a network, wherein the content comprises a content portion and an advertisement portion and is correlated with a content portion indicator that indicates the content portion and an advertisement portion indicator that indicates the advertisement portion;
the content distribution log recording device comprises:
means for recording a distribution log at the time of execution of distributing the content, wherein the distribution log is correlated with the content portion indicator and the advertisement portion indicator.

6. A computer program for a content distribution log recording device that records a distribution log of a content distributed across a network, wherein the content comprises a content portion and an advertisement portion and is correlated with a content portion indicator that indicates the content portion and an advertisement portion indicator that indicates the advertisement portion;
the program is implemented in a computer and capable of causing the computer perform:
means for recording a distribution log at the time of execution of distributing the content, wherein the distribution log is correlated with the content portion indicator and the advertisement portion indicator.

7. The device according to claims 4, 5, or 6 claim 4, further comprising:
means for outputting a content portion distribution log to a content provider which provides the content portion upon receiving a request for distribution log data from the content provider, wherein the content portion distribution log is retrieved from the log recording means based on the content portion indicator; and
means for outputting an advertisement portion distribution log to an advertisement provider which provides the advertisement portion upon receiving a request for distribution log data from the advertisement provider, wherein the advertisement portion distribution log is retrieved from the log recording means based on the advertisement portion indicator.

8. A content distribution log recording device for recording a distribution log of a content distributed across a network, wherein the content comprises a content portion and an advertisement portion and is correlated with a content portion indicator that indicates the content portion and an advertisement portion indicator that indicates the advertisement portion;
a central processing unit (CPU) of the content distribution log recording device is to execute the procedures of:
records a distribution log at the time of execution of distributing a content, wherein the distribution log is correlated with the content portion indicator and the advertisement portion indicator;
outputs a content portion distribution log to a content provider which provides the content portion upon receiving a request for distribution log data from the content provider, wherein the content portion distribution log is retrieved from the recorded distribution log based on the content portion indicator; and
outputs advertisement portion distribution log to an advertisement provider which provides the advertisement portion upon receiving a request for distribution log data from the advertisement provider, wherein the advertisement portion distribution log is retrieved from the recorded distribution log based on the advertisement portion indicator.

9. A end device for receiving the content distributed by the device according to claim 1.

10. A data for indicating a content comprising a content portion and an
advertisement portion;
the data comprises:
a unit for recording a content portion indicator that indicates the content portion;
a unit for recording an advertisement portion indicator that indicates the advertisement portion; and
a unit for recording a content indicator, wherein the content indicator is correlated with the content portion indicator and the advertisement portion indicator.

11. A method for distributing a content by using a computer, wherein the content comprises a content portion and an advertisement portion;
the method comprising the steps of:
storing a content, wherein the content is correlated with a content portion indicator that indicates the content portion and an advertisement portion indicator that indicates the advertisement portion; and
recording a distribution log at the time of execution of distributing the content, wherein the distribution log is correlated with the content portion indicator and the advertisement portion indicator.

12. A method for outputting a distribution log for a content by using a computer, wherein the content comprises a content portion and an advertisement portion;
the method comprising the steps of:
recording a distribution log at the time of execution of distributing the content, wherein the distribution log is correlated with a content portion indicator that indicates the content portion and an advertisement portion indicator that indicates the advertisement portion;
outputting a content portion distribution log to a content provider which provides the content portion upon receiving a request for distribution log data from the content provider, wherein the content portion distribution log is retrieved from the recorded distribution log based on the content portion indicator; and
outputting an advertisement portion distribution log to an advertisement provider which provides the advertisement portion upon receiving a request for distribution log data from the advertisement provider, wherein the advertisement portion distribution log is retrieved from the recorded distribution log based on the advertisement portion indicator.

13. A method for developing a content together with advertisement function, wherein the content comprises a promotional image for an artist;
the method comprising the steps of:
developing the content by incorporating an advertisement image for a product or a service into the promotional image.

14. A method for compensation allocation for a product placement content, wherein the content comprises a promotional image for an artist and an advertisement image for a product or a service incorporated into the promotional image;
the method comprising the steps of:
obtaining viewing logs; and
paying the compensation from an advertisement provider to a content provider on the basis of the viewing logs.

15. The device according to claim 2, further comprising:
means for recording a distribution log at the time of execution of the distributing means, wherein the distribution log is correlated with the content portion indicator and the advertisement portion indicator.

16. The device according to claim 5, further comprising:
means for outputting a content portion distribution log to a content provider which provides the content portion upon receiving a request for distribution log data from the content provider, wherein the content portion distribution log is retrieved from the log recording means based on the content portion indicator; and
means for outputting an advertisement portion distribution log to an advertisement provider which provides the advertisement portion upon receiving a request for distribution log data from the advertisement provider, wherein the advertisement portion distribution log is retrieved from the log recording means based on the advertisement portion indicator.

17. The device according to claim 6, further comprising:
means for outputting a content portion distribution log to a content provider which provides the content portion upon receiving a request for distribution log data from the content provider, wherein the content portion distribution log is retrieved from the log recording means based on the content portion indicator; and
means for outputting an advertisement portion distribution log to an advertisement provider which provides the advertisement portion upon receiving a request for distribution log data from the advertisement provider, wherein the advertisement portion distribution log is retrieved from the log recording means based on the advertisement portion indicator.

18. A end device for receiving the content distributed by the device according to claim 3.

19. A end device for receiving the content distributed by the device according to claim 4.

20. A end device for receiving the content distributed by the device according to claim 15.
